(19) United States
(12) Patent Application Publication
(10) Pub. No.: US 2025/0346383 A1
(43) Pub. Date: Nov. 13, 2025

(54) AUTOMATIC PACKAGING MECHANISM AND INTELLIGENT WATERLESS TOILET

(71) Applicants: Jiangsu Sanjo Intelligent Technology Co., Ltd., Jiangsu (CN); Ray Robot(Ningbo) Co., LTD, Shanghai (CN)

(72) Inventors: Heping XIAO, Jiangsu (CN); Lei WANG, Jiangsu (CN); Jiang ZHANG, Jiangsu (CN)

(73) Assignees: Jiangsu Sanjo Intelligent Technology Co., Ltd., Jiangsu (CN); Ray Robot(Ningbo) Co., LTD, Shanghai (CN)

(21) Appl. No.: 19/026,525

(22) Filed: Jan. 17, 2025

(30) Foreign Application Priority Data
May 8, 2024 (CN) 202410564124.6

(51) Int. Cl. B65B 51/14; A47K 11/02

(52) U.S. Cl. CPC B65B 51/146; A47K 11/023; A47K 11/026

(57) ABSTRACT

An automatic packaging mechanism includes a melting assembly having a heating structure, a gathering assembly, and a buffer. The gathering assembly includes a gathering base and a pressing base. A passage is formed between the pressing base and the heating structure. The gathering base is driven by a drive member to move toward or away from the heating structure. The buffer is slidably sleeved over an outer periphery of the melting base. When the drive member drives the gathering base to move toward the heating structure, the pressing base contacts the buffer and contacts the heating structure, and an opening of a garbage bag to be heat-sealed is gathered between the pressing base and the heating structure by the gathering base. Upper and lower parts of the heating structure simultaneously seal adjacent garbage bags, and a middle part of the heating structure cuts the sealed garbage bags apart.

### CROSS-REFERENCE TO RELATED APPLICATION

This application claims the priority benefit of China application serial no. 202410564124.6, filed on May 8, 2024. The entirety of the above-mentioned patent application is hereby incorporated by reference herein and made a part of this specification.

### BACKGROUND

### Technical Field

The present disclosure belongs to the technical field of sanitary equipment, and specifically relates to an automatic packaging mechanism and an intelligent waterless toilet.

### Description of Related Art

Nowadays, the use of automatic packaging mechanisms is required on various occasions such as packaging of garbage for recycling and packaging of takeout for carrying out. Existing intelligent waterless toilets also require the use of an automatic packaging mechanism to package excrement. For example, Chinese Patent Application No. CN110913735A discloses a waterless toilet for recreational vehicles, which is equipped with an automatic packaging mechanism including sealing devices and a heating element. The automatic packaging process of the waterless toilet is as follows. After excrement falls into a garbage bag, the sealing devices first seal the garbage bag, and then the heating element cuts off the garbage bag through melting, so that the packaged garbage bag is separated from the garbage bag roll.

Existing automatic packaging mechanisms have the following disadvantages. First, two sealing devices are required, one for sealing an upper end of the garbage bag containing excrement, and the other for sealing a lower end of a new garbage bag to hold excrement next time. Then, the garbage bag containing excrement is cut off through melting between the two sealed ends by a heating element. Therefore, the existing current automatic packaging mechanisms have a complex structure, a complicated packaging process, and high packaging costs. Second, the packaged garbage bag is filled with air and therefore has a large volume that takes up much space, leading to a waste of space resources. Third, the garbage bag is likely to stick to the sealing devices and/or the heating element, resulting in sealing defects or even failure.

With the development of economy and technology, the market prospect of automatic packaging is broad. Therefore, it is necessary to overcome the above-mentioned disadvantages of the existing automatic packaging mechanisms and design an automatic packaging mechanism with a simple structure that provides convenience, reliability, and stability.

### SUMMARY

To solve the problems of the complex structure and the poor packaging quality of the existing automatic packaging mechanisms in the prior art, the present disclosure provides an automatic packaging mechanism and an intelligent waterless toilet.

To solve the above-mentioned technical problems, the following technical solutions are employed in the present disclosure. An automatic packaging mechanism is provided, including:
a hot melting assembly, where the hot melting assembly includes a hot melting base and a heating structure arranged on the hot melting base;
a gathering assembly, where the gathering assembly includes a gathering base and a pressing base, and the pressing base is arranged on the gathering base, a garbage bag passage is formed between the pressing base and the heating structure, a material strip of a garbage bag opened passes through the garbage bag passage, and the gathering base is configured to be driven by a gathering drive member to move toward or away from the heating structure; and
a buffer assembly, where the buffer assembly is slidably sleeved over an outer periphery of the hot melting base, and when the gathering drive member drives the gathering base to move toward the heating structure, the pressing base first comes into contact with the buffer assembly and then comes into contact with the heating structure, and an opening of a garbage bag to be heat-sealed is gathered between the pressing base and the heating structure by the gathering base; and an upper part and a lower part of the heating structure are configured to simultaneously seal two garbage bags adjacent to each other, respectively, and a middle part of the heating structure is configured to cut the two sealed garbage bags apart from each other through melting.

Preferably, the buffer assembly includes a buffer base and an elastic member, the buffer base is slidably sleeved over the outer periphery of the hot melting base, and the elastic member is arranged between the buffer base and the hot melting base. When a garbage bag needs to be sealed and cut off by melting, the gathering drive member drives the gathering base to move toward the heating structure. In this case, the gathering base gathers the opening of the garbage bag to be heat-sealed between the pressing base and the heating structure. Because the pressing base first comes into contact with the buffer base of the buffer assembly, the opening of the garbage bag to be heat-sealed is first gathered between the pressing base and the buffer base. After an elastic force of the elastic member is overcome, the buffer base moves backward. The pressing base presses the gathered opening of the garbage bag to be heat-sealed onto the heating structure for heat sealing and cutting off through melting. In this way, sealing defects or even failure due to uneven heating caused by different parts of the opening of the garbage bag to be heat-sealed coming into contact with the heating structure at different times is avoided. In addition, after the garbage bag is sealed and cut off, the pressing base moves backward to an original position thereof. In this case, the buffer base moves to an original position thereof under the action of the elastic member. The buffer base ensures that the opening of the garbage bag heat-sealed is pulled off and detached from the heating structure, thereby effectively preventing the opening of the garbage bag heat-sealed from sticking to the heating structure.

Further, the buffer assembly further includes a guide rod, the buffer base is slidably sleeved over the guide rod, a limiting member is arranged on the guide rod, and the buffer base is arranged between the limiting member and the elastic member. This ensures reliable and stable sliding of the buffer base, and achieves a simple structure, convenient assembly, and lower costs.

Preferably, gathering portions are respectively arranged at an upper part and a lower part of the gathering base, the pressing base is arranged between the gathering portions at the upper part and the lower part of the gathering base, and each of the gathering portions has a flared shape toward the heating structure. The gathering portions skillfully avoid the pressing base and the heating structure, and effectively gather the opening of the garbage bag to be heat-sealed without clamping or jamming the opening of the garbage bag to be heat-sealed.

Further, the gathering drive member includes a synchronous belt structure and a gathering motor, an output end of the gathering motor is drivingly connected to an input end of the synchronous belt structure, a left end and a right end of the gathering base are connected to the synchronous belt structure, and the gathering base is slidably sleeved over the guide rod of the buffer assembly. The gathering drive member has a simple structure that can be easily configured, and uses a mature conveying technology that provides reliable and stable conveying at lower costs.

Preferably, an exhaust sheet is arranged below the gathering base, a drawer is arranged below the garbage bag passage, the gathering base is configured to move toward the heating structure in a rear-to-front direction, and the exhaust sheet is arranged to be inclined forward in a top-to-bottom direction. In the process of the gathering base gathering the opening of the garbage bag to be heat-sealed toward the heating structure, the gathering base drives the exhaust sheet to cooperate with an inner wall of the drawer to squeeze the garbage bag to discharge air. Such a skillful configuration greatly reduces the volume of the packaged garbage bag, and the packaged garbage bag falls into the drawer for temporary storage, thereby improving the space utilization.

Further, the exhaust sheet is hingedly connected to the gathering base by a damping hinge, the exhaust sheet has a T-shape with a larger bottom and a smaller top, and a plurality of exhaust holes are formed through the exhaust sheet. As such, hard contact between the exhaust sheet and the garbage bag is avoided, thereby effectively protecting the exhaust sheet and the garbage bag.

Preferably, the heating structure includes a heating sheet and a thermally conductive sheet, the hot melting base, the heating sheet, and the thermally conductive sheet are arranged facing the gathering base in sequence, a middle part of the thermally conductive sheet is provided with a protruding portion extending toward the gathering base, and the protruding portion is configured to cut the two sealed garbage bags apart from each other through melting. The hot melting assembly of the present disclosure may be a hot melting sealing and cutting assembly disclosed in Chinese Patent Application No. 202021449543.9 entitled “Hot Melting Sealing and Cutting Device,” which can seal an upper end of a garbage bag containing excrement and a lower end of a new garbage bag, and at the same time, cut the sealed garbage bags apart from each other through melting. The hot melting assembly has a simple and reliable structure, a small volume, high efficiency, and lower costs.

Preferably, the thermally conductive sheet is T-shaped, and more preferably, the thermally conductive sheet is made of copper.

Further, a high-temperature resistant diaphragm is attached to each of an inner side and an outer side of the thermally conductive sheet. The high-temperature resistant diaphragm is an adhesive tape made of a high-temperature resistant material or an insulating paint made of a high-temperature resistant material to ensure the sealing quality.

Further, the hot melting assembly further includes a temperature sensor arranged on the hot melting base. As such, the temperature of the heating structure can be precisely detected and controlled, thereby improving the effects of heat sealing and cutting off through melting.

Preferably, the automatic packaging mechanism further includes a garbage bag pull-down assembly, where the garbage bag pull-down assembly is arranged above the garbage bag passage, and is configured to convey the material strip of the garbage bag opened toward the garbage bag passage in turn. The garbage bag pull-down assembly of the present disclosure is a plastic bag pull-down device for an intelligent packaging toilet disclosed in Chinese Patent Application No. 202311161934.9, which has a simple structure and provides reliable and stable operation at lower costs.

Further, the automatic packaging mechanism further includes a supporting base, where the hot melting assembly, the gathering assembly, and the garbage bag pull-down assembly are arranged in the supporting base. In other words, the automatic packaging mechanism is integrated on the supporting base to facilitate modular production, assembly, etc., and reduce the costs.

An intelligent waterless toilet is provided, including the automatic packaging mechanism according to any one of the above embodiments, where the automatic packaging mechanism further includes a supporting base, the hot melting assembly, the gathering assembly, and the garbage bag pull-down assembly are arranged in the supporting base, and the supporting base is arranged in a housing of the intelligent waterless toilet.

Preferably, the intelligent waterless toilet further includes a fixed base, and the housing of the intelligent waterless toilet is connected to the fixed base. The intelligent waterless toilet is arranged in a recreational vehicle, and the fixed base makes it convenient to install the intelligent waterless toilet in the recreational vehicle.

Preferably, the intelligent waterless toilet further includes a rotary base, where the intelligent waterless toilet is arranged in a recreational vehicle, and the housing of the intelligent waterless toilet is connected to the rotary base. The rotary base allows for the adaptive adjustment of the orientation of the intelligent waterless toilet in a limited space of the recreational vehicle.

Further, the rotary base includes a base body, a turntable, and a slide buckle drive member, the slide buckle drive member includes a button, a lever assembly, and slide buckles, an annular groove is provided on an upper surface of the base body, the turntable is rotatably arranged in the annular groove, the turntable includes a limiting flange extending outward along a radial direction of the turntable, the slide buckles are slidably arranged on the base body, the button and the lever assembly are arranged on the base body, an input end of the lever assembly is connected to the button, an output end of the lever assembly is connected to the slide buckles to drive the slide buckles to slide toward or away from the turntable, a first elastic reset member is arranged between the button and the base body, a second elastic reset member is arranged between each of the slide buckles and the base body, and when the slide buckles slide toward the turntable, the slide buckles hook the limiting flange to restrict an axial movement of the turntable, and each of the slide buckles radially presses against the turntable under an action of the second elastic reset member. The button is pressed downward to cause the slide buckle drive member to drive the slide buckles to disengage from the turntable, so that the turntable can be freely rotated to easily adjust the orientation of the intelligent waterless toilet. Alternatively, the intelligent waterless toilet is directly rotated, so that the housing of the intelligent waterless toilet overcomes the resistance of the second elastic reset member and drives the turntable to rotate to adjust the orientation of the intelligent waterless toilet. The second elastic reset member provides a certain damping effect during the rotation of the turntable, improving the user's operation experience. In addition, the second elastic reset member effectively prevents the intelligent waterless toilet from accidentally rotating.

Further, the lever assembly includes a push plate and two levers, the two levers are rotatably connected to the base body, the two levers are symmetrically arranged along the radial direction of the turntable, a distal end of each of the two levers is connected to a respective one of the slide buckles, the slide buckles are respectively provided with second limiting portions, and each of the second limiting portions extends downward from an end of a respective one of the slide buckles away from the limiting flange, and the distal end of each of the two levers is always in contact with a respective one of the second limiting portions; and a proximal end of each of the two levers is connected to the push plate, the push plate is connected to the button, the push plate includes first limiting portions respectively extending from two sides of the push plate, the proximal end of each of the two levers is located between the first limiting portions on the two sides of the push plate, and when the button is pressed downward, the push plate presses the proximal end of each of the two levers simultaneously. The lever assembly has a simple and reliable structure, lower costs, and a reasonable and skillful layout, and can save the installation space and greatly reduce the force required for operation, and can be easily mounted and operated.

Further, an upper part of the turntable is arranged higher than the annular groove, a diameter of the upper part of the turntable is greater than a diameter of the annular groove, and the housing of the intelligent waterless toilet is connected to the upper part of the turntable; and the button is located on a front side of the intelligent waterless toilet. As such, in a limited space of the recreational vehicle, the intelligent waterless toilet can be installed or rotated relative to the rotary base by pressing the button downward. Therefore, the intelligent waterless toilet can be adaptively installed in various orientations according to an actual installation scenario, and the user can change the orientation of the intelligent waterless toilet according to his/her own habits when using the intelligent waterless toilet.

### Advantages

1. In the automatic packaging mechanism of the present disclosure, when a garbage bag needs to be sealed and cut off by melting, the gathering drive member drives the gathering base to move toward the heating structure. In this case, the gathering base gathers an opening of the garbage bag to be heat-sealed between the pressing base and the heating structure. Because the pressing base first comes into contact with the buffer assembly, the opening of the garbage bag to be heat-sealed is first gathered between the pressing base and the buffer base. After a buffering force of the buffer assembly is overcome, the buffer assembly moves backward. The pressing base presses the gathered opening of the garbage bag to be heat-sealed onto the heating structure for heat sealing and cutting off through melting. In this way, sealing defects or even failure due to uneven heating caused by different parts of the opening of the garbage bag coming into contact with the heating structure at different times is avoided. In addition, after the garbage bag is sealed and cut off, the pressing base moves backward to the original position thereof. In this case, the buffer assembly moves to the original position thereof under the buffering force. The buffer assembly ensures that the opening of the garbage bag heat-sealed is pulled off and detached from the heating structure, thereby effectively preventing the opening of the garbage bag heat-sealed from sticking to the heating structure.

2. In the automatic packaging mechanism of the present disclosure, the lower part of the heating structure seals the upper end of the garbage bag containing excrement, the upper part of the heating structure seals a lower end of a new garbage bag, and at the same time, the middle part of the heating structure cuts the sealed garbage bags apart from each other through melting.

Whereby, a high degree of integration of heat sealing and cutting off through melting is achieved. The automatic packaging mechanism thus provides a simple, reliable, skillful design for convenient packaging with lower costs.

3. The intelligent waterless toilet of the present disclosure includes the automatic packaging mechanism and the rotary base, allowing the intelligent waterless toilet to be rotated to any angle to adapt to different installation scenarios and usage scenarios. When using the intelligent waterless toilet, a user can change the orientation of the intelligent waterless toilet according to his or her habit. There are two ways to change the orientation of the intelligent waterless toilet. One is to directly rotate the housing of the intelligent waterless toilet, so that the housing of the intelligent waterless toilet overcomes resistance of the second elastic reset member and drives the turntable to rotate to adjust the orientation of the intelligent waterless toilet. The second elastic reset member provides a certain damping effect during rotation of the turntable, improving the user's operation experience. The other is to press the button downward to cause the two slide buckles to slide away from each other and detach from the limiting flange. In this case, the turntable can be rotated to any angle to adjust the orientation of the intelligent waterless toilet. As such, the force required to adjust the orientation of the intelligent waterless toilet is greatly reduced, making the operation more convenient, and allowing vulnerable groups to easily operate the intelligent waterless toilet.

### BRIEF DESCRIPTION OF THE DRAWINGS

In order to more clearly explain the technical solutions in the embodiments of the present disclosure, the drawings used in the description of the embodiments will be briefly described below. Obviously, the drawings depicted below are merely embodiments of the present disclosure, and those skilled in the art can obtain other drawings based on these drawings without any creative efforts.

FIG. 1 is a three-dimensional schematic structural diagram of an automatic packaging mechanism according to the present disclosure.

FIG. 2 is a three-dimensional schematic structural diagram of the automatic packaging mechanism in FIG. 1 from another angle.

FIG. 3 is a three-dimensional schematic structural diagram of a hot melting assembly, a gathering assembly, a buffer assembly, and a garbage bag pull-down assembly of the automatic packaging mechanism according to the present disclosure.

FIG. 4 is a three-dimensional schematic structural diagram of the automatic packaging mechanism in FIG. 3 from another angle.

FIG. 5 is a three-dimensional schematic structural diagram of a hot melting assembly, a gathering assembly, and a buffer assembly of the automatic packaging mechanism according to the present disclosure.

FIG. 6 is a three-dimensional schematic exploded view of the automatic packaging mechanism in FIG. 5.

FIG. 7 is a three-dimensional schematic structural diagram of a hot melting assembly and a buffer assembly of the automatic packaging mechanism according to the present disclosure.

FIG. 8 is a three-dimensional schematic exploded view of the automatic packaging mechanism in FIG. 7.

FIG. 9 is a three-dimensional schematic structural diagram of an intelligent waterless toilet according to the present disclosure.

FIG. 10 is a three-dimensional schematic exploded view of the intelligent waterless toilet in FIG. 9.

FIG. 11 is a schematic cross-sectional view of the intelligent waterless toilet in FIG. 9.

FIG. 12 is a three-dimensional schematic structural diagram of a rotary base of the intelligent waterless toilet according to the present disclosure.

FIG. 13 is a schematic cross-sectional view of the intelligent waterless toilet in FIG. 12.

FIG. 14 is a three-dimensional schematic exploded view of the intelligent waterless toilet in FIG. 12.

FIG. 15 is a three-dimensional schematic structural diagram of the intelligent waterless toilet in FIG. 14 from another angle, where the base body is not shown.

FIG. 16 is a three-dimensional schematic structural diagram of an intelligent waterless toilet using a fixed base according to the present disclosure.

### DESCRIPTION OF THE EMBODIMENTS

The technical solutions in the embodiments of the present disclosure will be described clearly and fully with reference to the accompanying drawings in the embodiments of the present disclosure. Apparently, the embodiments described are merely some embodiments, rather than all of the embodiments of the present disclosure. The following descriptions of at least one exemplary embodiment are merely illustrative, and in no way constitute any limitation on the present disclosure and application or use of the present disclosure. All other embodiments obtained by those of ordinary skill in the art without creative efforts based on the embodiments of the present disclosure shall fall within the protection scope of the present disclosure.

### Embodiment 1

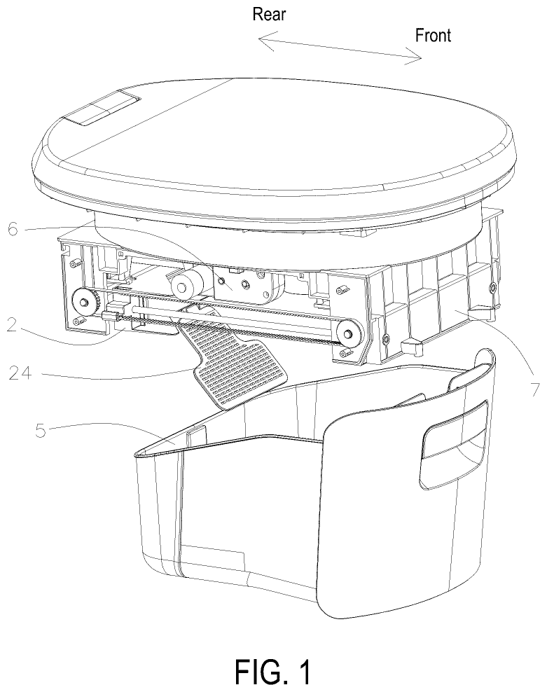

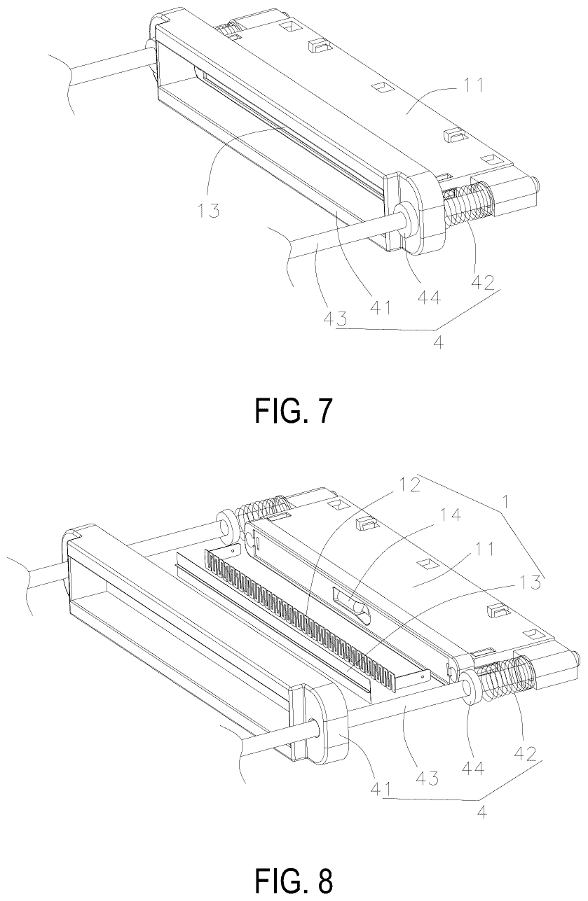

As shown in FIG. 1 to FIG. 8, an automatic packaging mechanism includes a hot melting assembly 1, a gathering assembly 2, and a buffer assembly 4. The hot melting assembly 1 includes a hot melting base 11 and a heating structure arranged on the hot melting base 11. The gathering assembly 2 includes a gathering base 21 and a pressing base 22. The pressing base 22 is arranged on the gathering base 21. A garbage bag passage 3 is formed between the pressing base 22 and the heating structure. A material strip of a garbage bag opened passes through the garbage bag passage 3. The gathering base 21 is configured to be driven by a gathering drive member 23 to move toward or away from the heating structure. The buffer assembly 4 is slidably sleeved over an outer periphery of the hot melting base 11. When the gathering drive member 23 drives the gathering base 21 to move toward the heating structure, the pressing base 22 first comes into contact with the buffer assembly 4 and then comes into contact with the heating structure, and an opening of a garbage bag to be heat-sealed is gathered between the pressing base 22 and the heating structure by the gathering base 21. An upper part and a lower part of the heating structure are configured to simultaneously seal two garbage bags adjacent to each other, respectively, i.e., simultaneously seal a bottom end of a new garbage bag and a top end of the current garbage bag, and a middle part of the heating structure is configured to cut the two sealed garbage bags apart from each other through melting. In this embodiment, the user faces forward when using the intelligent waterless toilet.

Specifically, in this embodiment, as shown in FIG. 1 to FIG. 4, the automatic packaging mechanism further includes a garbage bag pull-down assembly 6, and the garbage bag pull-down assembly 6 is arranged above the garbage bag passage 3, and is configured to convey the material strip of the garbage bag opened toward the garbage bag passage 3 in turn. In this embodiment, the garbage bag pull-down assembly 6 is a plastic bag pull-down device for an intelligent packaging toilet disclosed in Chinese Patent Application No. 202311161934.9.

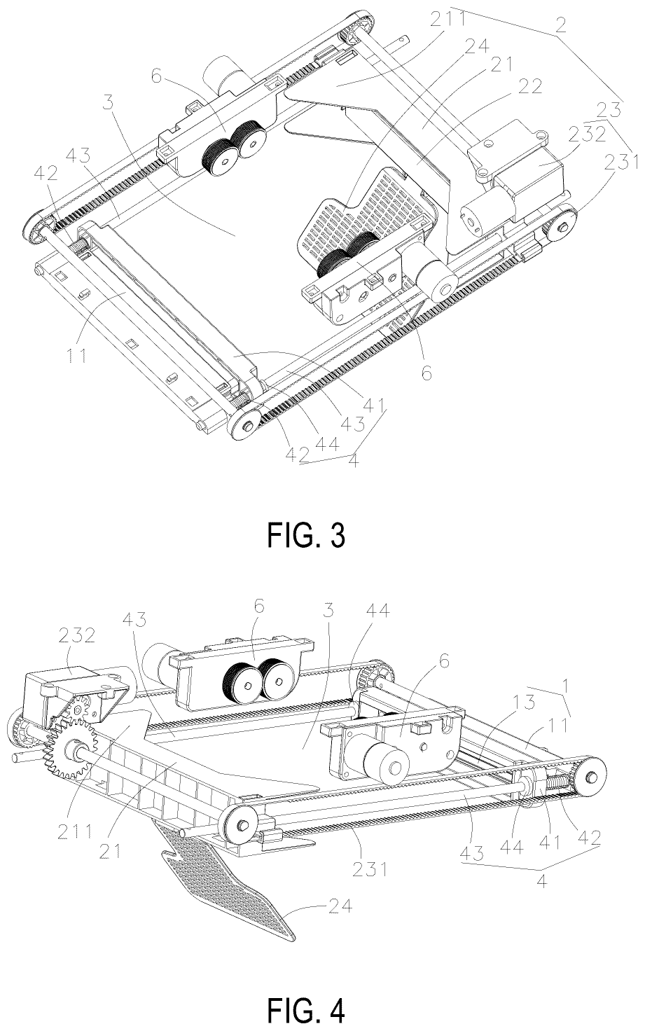

Specifically, in this embodiment, as shown in FIG. 3 to FIG. 8, the buffer assembly 4 includes a buffer base 41 and an elastic member 42, the buffer base 41 is slidably sleeved over the outer periphery of the hot melting base 11, and the elastic member 42 is arranged between the buffer base 41 and the hot melting base 11. Further, in this embodiment, the buffer assembly 4 further includes a guide rod 43, the buffer base 41 is slidably sleeved over the guide rod 43, a limiting member 44 is arranged on the guide rod 43, and the buffer base 41 is arranged between the limiting member 44 and the elastic member 42. In this embodiment, the limiting member 44 is a circlip.

Specifically, in this embodiment, as shown in FIG. 3 to FIG. 6, gathering portions 211 are respectively arranged at an upper part and a lower part of the gathering base 21, the pressing base 22 is arranged between the gathering portions 211 at the upper part and the lower part of the gathering base 21, and each of the gathering portions 211 has a flared shape toward the heating structure. The gathering portions 211 skillfully avoid the pressing base 22 and the heating structure, and effectively gather the opening of the garbage bag to be heat-sealed without clamping or jamming the opening of the garbage bag to be heat-sealed. Further, in this embodiment, an exhaust sheet 24 is arranged below the gathering base 21, a drawer 5 is arranged below the garbage bag passage 3, the gathering base 21 is configured to move toward the heating structure in a rear-to-front direction, and the exhaust sheet 24 is arranged to be inclined forward in a top-to-bottom direction. In the process of the gathering base 21 gathering the opening of the garbage bag to be heat-sealed toward the heating structure, the gathering base 21 drives the exhaust sheet 24 to cooperate with an inner wall of the drawer 5 to squeeze the garbage bag to discharge air. Such a skillful configuration greatly reduces the volume of the packaged garbage bag, and the packaged garbage bag falls into the drawer 5 for temporary storage, thereby improving the space utilization. Further, in this embodiment, the exhaust sheet 24 is hingedly connected to the gathering base 21 by a damping hinge, the exhaust sheet 24 has a T-shape with a larger bottom and a smaller top, and a plurality of exhaust holes are formed through the exhaust sheet 24. As such, hard contact between the exhaust sheet 24 and the garbage bag is avoided, thereby effectively protecting the exhaust sheet 24 and the garbage bag.

Specifically, in this embodiment, as shown in FIG. 3 to FIG. 6, the gathering drive member 23 includes a synchronous belt structure 231 and a gathering motor 232, an output end of the gathering motor 232 is drivingly connected to an input end of the synchronous belt structure 231, a left end and a right end of the gathering base 21 are connected to the synchronous belt structure 231, and the gathering base 21 is slidably sleeved over the guide rod 43 of the buffer assembly 4.

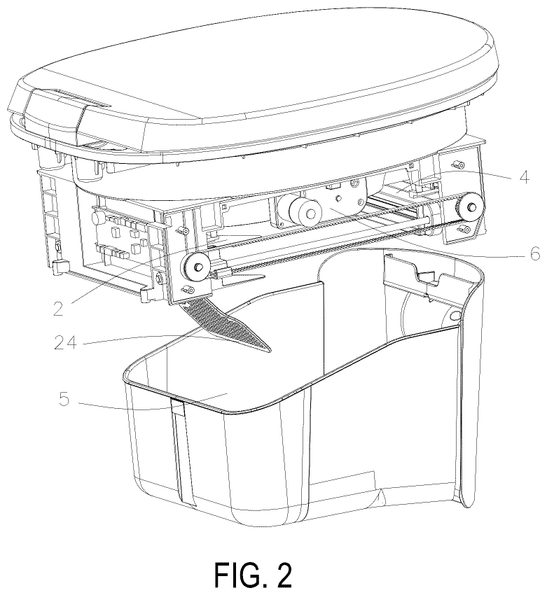

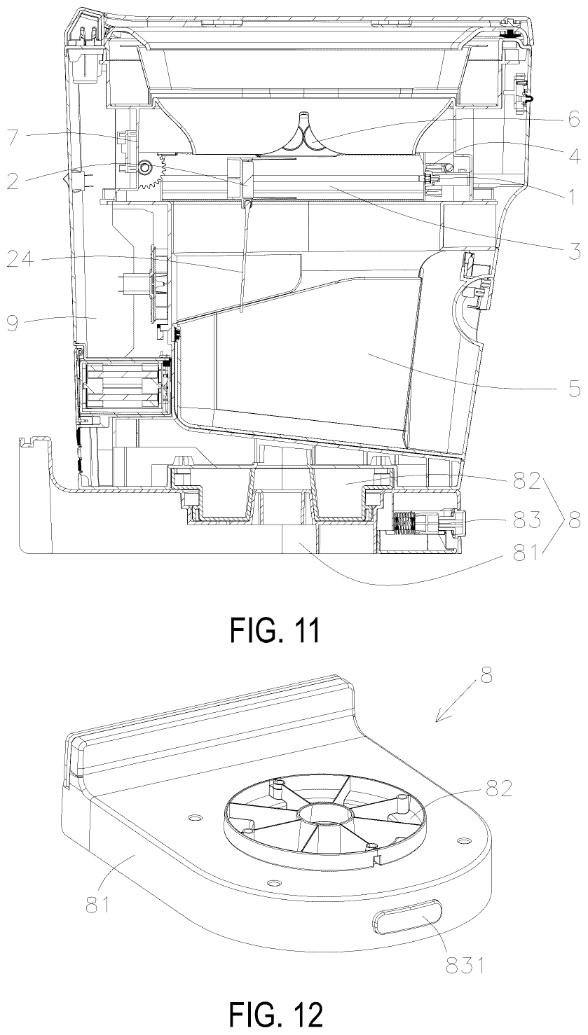

Specifically, in this embodiment, as shown in FIG. 1, FIG. 2, FIG. 10, and FIG. 11, the automatic packaging mechanism further includes a supporting base 7. The hot melting assembly 1, the gathering assembly 2, and the garbage bag pull-down assembly 6 are arranged in the supporting base 7. In other words, the automatic packaging mechanism is integrated on the supporting base 7, to facilitate modular production, assembly, etc., and reduce the costs.

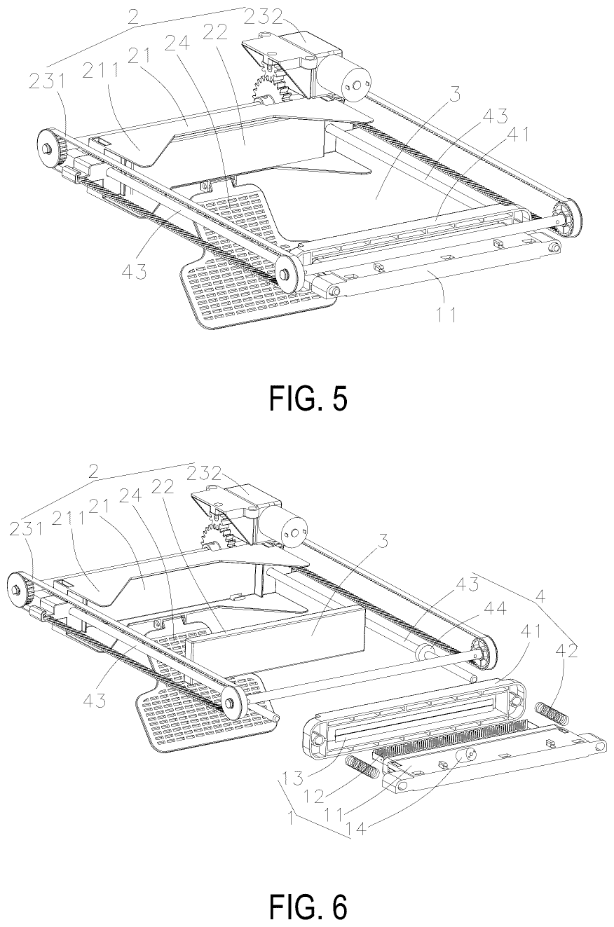

Specifically, in this embodiment, as shown in FIG. 5 to FIG. 8, the heating structure includes a heating sheet 12 and a thermally conductive sheet 13, the hot melting base 11, the heating sheet 12, and the thermally conductive sheet 13 are arranged facing the gathering base 21 in sequence, a middle part of the thermally conductive sheet 13 is provided with a protruding portion extending toward the gathering base 21, and the protruding portion is configured to cut the two sealed garbage bags apart from each other through melting. Further, in this embodiment, the hot melting assembly 1 further includes a temperature sensor 14 arranged on the hot melting base 11. In this embodiment, the thermally conductive sheet 13 is a T-shaped copper sheet. Further, in this embodiment, a high-temperature resistant diaphragm (not shown) is attached to each of an inner side and an outer side of the thermally conductive sheet 13. In this embodiment, the high-temperature resistant diaphragm is an adhesive tape made of a high-temperature resistant material or an insulating paint made of a high-temperature resistant material. In this embodiment, the hot melting assembly 1 may be a hot melting sealing and cutting assembly disclosed in Chinese Patent Application No. 202021449543.9 entitled “Hot Melting Sealing and Cutting Device”, which can seal an upper end of a garbage bag containing excrement and a lower end of a new garbage bag, and at the same time, cut the sealed garbage bags apart from each other through melting. The hot melting assembly 1 has a simple and reliable structure, a small volume, high efficiency, and lower costs.

The automatic packaging mechanism of the present disclosure can be applied to an intelligent waterless toilet to automatically package excrement, and can also be applied to other usage scenarios requiring automatic packaging, such as packaging of garbage for recycling, packaging of food and other items, etc.

A packaging process of the automatic packaging mechanism is as follows.

The material strip of the garbage bag opened is passed through the garbage bag passage, and the garbage bag pull-down assembly 6 conveys the material strip of the garbage bag opened toward the garbage bag passage 3 in turn. When a garbage bag needs to be sealed and cut off by melting, the gathering motor is turned on to drive the synchronous belt structure 231 to drive the gathering base 21 to move toward the thermally conductive sheet 13. In this case, the gathering portions 211 of the gathering base 21 gather an opening of the garbage bag to be heat-sealed between the pressing base 22 and the thermally conductive sheet 13. The pressing base 22 first comes into contact with the buffer base 41 of the buffer assembly 4, and the opening of the garbage bag to be heat-sealed is first gathered between the pressing base 22 and the buffer base 41 to effectively avoid sealing defects or even failure due to uneven heating caused by different parts of the opening of the garbage bag coming into contact with the thermally conductive sheet 13 at different times. After an elastic force of the elastic member 42 is overcome, the buffer base 41 moves backward. The pressing base 22 presses the gathered opening of the garbage bag to be heat-sealed onto the thermally conductive sheet 13 for heat sealing and cutting off through melting. Specifically, a lower part of the thermally conductive sheet 13 seals the upper end of the garbage bag containing excrement, the upper part of the thermally conductive sheet 13 seals a lower end of a new garbage bag, and at the same time, the protruding portion cuts the sealed garbage bags apart from each other through melting. The synchronous belt structure 231 then drives the gathering base 21 to move away from the thermally conductive sheet 13. In this case, the pressing base 22 is separated from the thermally conductive sheet 13 and the buffer base 41, and the buffer base 41 moves to the original position thereof under the action of the elastic member 42. The buffer base 41 ensures that the opening of the garbage bag heat-sealed is pulled off and detached from the thermally conductive sheet 13, thereby effectively preventing the opening of the garbage bag heat-sealed from sticking to the thermally conductive sheet 13. The packaged garbage bag automatically falls into the drawer 5 for temporary storage. The garbage bag pull-down assembly 6 further conveys the material strip of the garbage bag opened toward the garbage bag passage 3 for a distance which is equal to the length of one garbage bag, to prepare for a next packaging operation.

### Embodiment 2

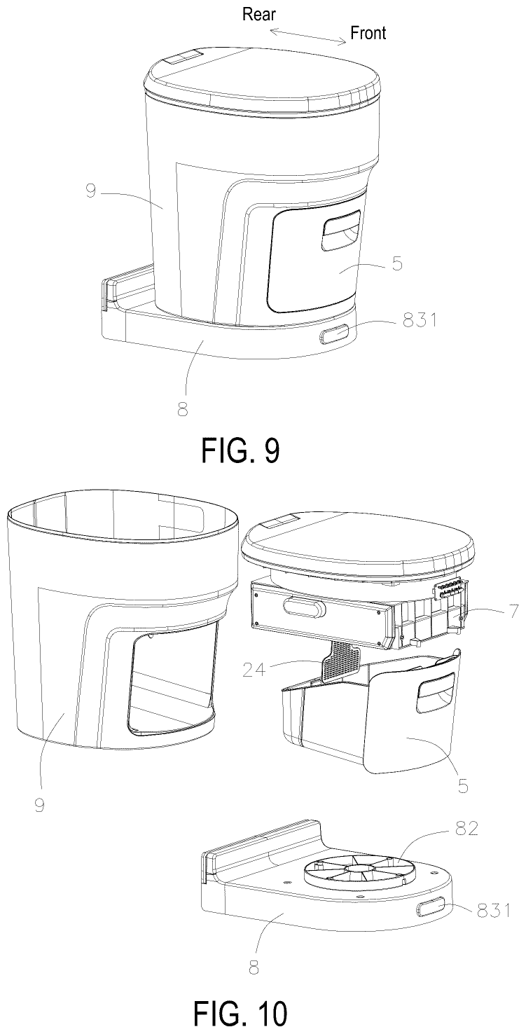

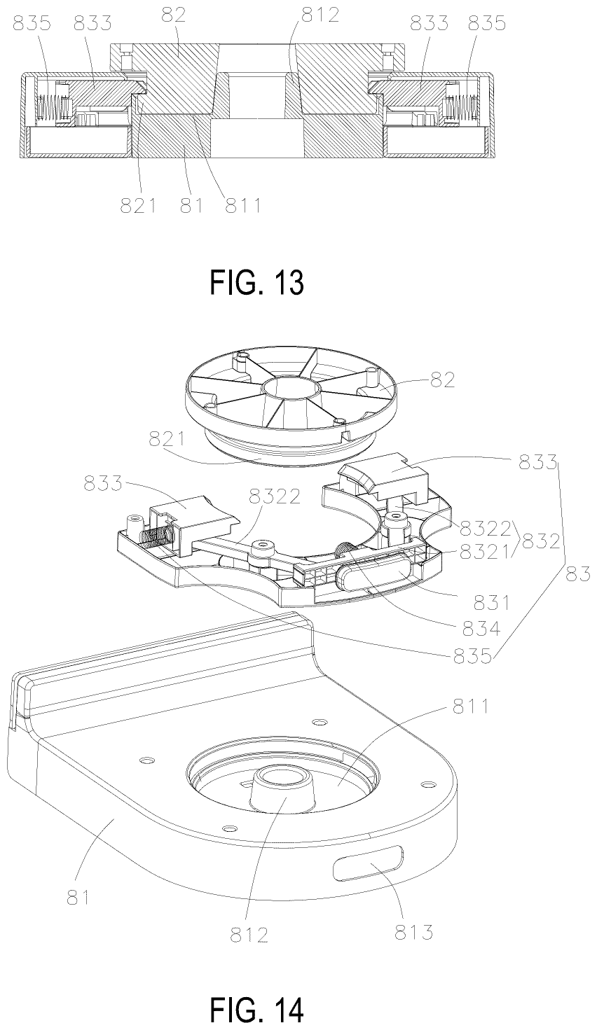

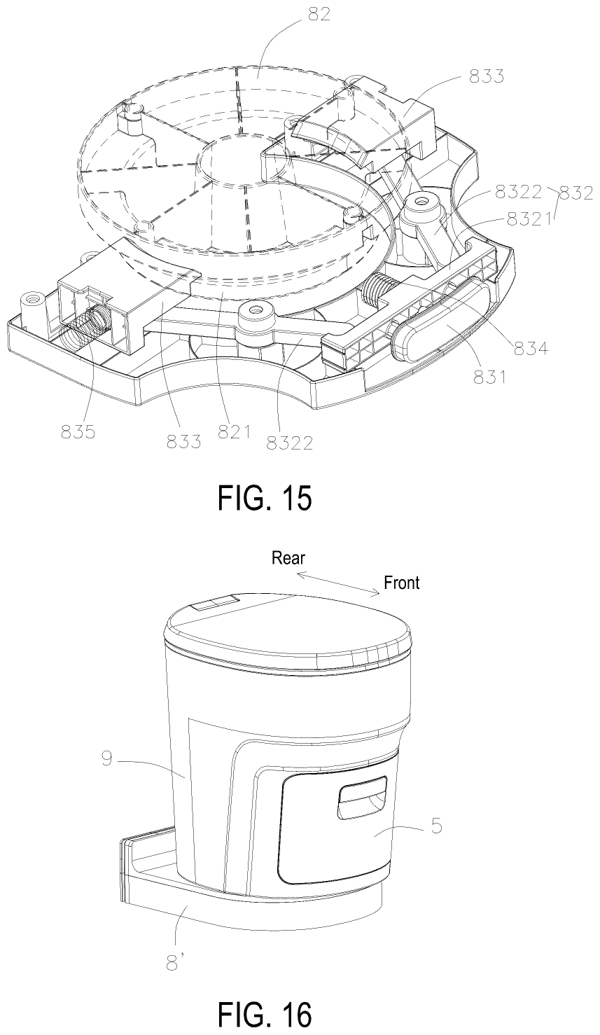

As shown in FIG. 9 to FIG. 15, an intelligent waterless toilet is provided. In this embodiment, the intelligent waterless toilet includes the automatic packaging mechanism of Embodiment 1, and the supporting base 7 of the automatic packaging mechanism is arranged in a housing 9 of the intelligent waterless toilet. The intelligent waterless toilet further includes a rotary base 8. The intelligent waterless toilet is arranged in a recreational vehicle, and the housing 9 of the intelligent waterless toilet is connected to the rotary base 8. The rotary base allows for the adaptive adjustment of the orientation of the intelligent waterless toilet in a limited space of the recreational vehicle. In this embodiment, the user faces forward when using the intelligent waterless toilet.

Specifically, in this embodiment, as shown in FIG. 12 to FIG. 15, the rotary base 8 includes a base body 81, a turntable 82, and a slide buckle drive member 83. The slide buckle drive member 83 includes a button 831, a lever assembly 832, and slide buckles 833. An annular groove 811 is provided on an upper surface of the base body 81. The turntable 82 is rotatably arranged in the annular groove 811. A boss shaft 812 configured to engage with the turntable 82 is provided in the annular groove 811. The turntable 82 includes a limiting flange 821 extending outward along a radial direction of the turntable 82. The slide buckles 833 are slidably arranged on the base body 81. The button 831 and the lever assembly 832 are arranged on the base body 81. An input end of the lever assembly 832 is connected to the button 831. An output end of the lever assembly 832 is connected to the slide buckles 833 to drive the slide buckles 833 to slide toward or away from the turntable 82. A first elastic reset member 834 is arranged between the button 831 and the base body 81. A second elastic reset member 835 is arranged between each of the slide buckles 833 and the base body 81. When the slide buckles 833 slide toward the turntable 82, the slide buckles 833 hook the limiting flange 821 to restrict an axial movement of the turntable 82, and the slide buckles 833 radially press against the turntable 82 under action of the second elastic reset members 835. Further, in this embodiment, the lever assembly 832 includes a push plate 8321 and two levers 8322. The two levers 8322 are rotatably connected to the base body 81. The two levers 8322 are symmetrically arranged along the radial direction of the turntable 82. A distal end of each of the two levers 8322 is connected to a respective one of the slide buckles 833. The slide buckles 833A are respectively provided with second limiting portions, and each of the second limiting portions extends downward from an end of a respective one of the slide buckles 833 away from the limiting flange 821. The distal end of each of the two levers 8322 is always in contact with a respective one of the second limiting portions. A proximal end of each of the two levers 8322 is connected to the push plate 8321. The push plate 8321 is connected to the button 831. The push plate 8321 includes first limiting portions respectively extending from two sides of the push plate 8321. The proximal end of each of the two levers 8322 is located between the first limiting portions on the two sides of the push plate 8321. When the button 831 is pressed downward, the push plate 8321 presses the proximal end of each of the two levers 8322 simultaneously. Further, in this embodiment, an upper part of the turntable 82 is arranged higher than the annular groove 811, a diameter of the upper part of the turntable 82 is greater than a diameter of the annular groove 811, and the housing 9 of the intelligent waterless toilet is connected to the upper part of the turntable 82; and the button 831 is located on a front side of the intelligent waterless toilet.

An installation process of the rotary base 8 of the intelligent waterless toilet is as follows.

First, the assembled rotary base 8 is mounted at a reserved position in the recreational vehicle. It should be noted that in this case, the turntable 82 is separated from the rotary base 8 as an independent component. The independent turntable 82 is mounted at a bottom of the housing 9 of the intelligent waterless toilet, and then mounted on the rotary base 8. The button 831 is pressed downward to drive the push plate 8321, the levers 8322, and the slide buckles 833 in sequence, so that the two slide buckles 833 slide away from each other. In this case, a lower part of the turntable 82 may be inserted into the annular groove 811. When the upper part of the turntable 82 is located above the annular groove 811, the button 831 is released, so that the button 831 moves back to the original position thereof under the action of the first elastic reset member 834, and at the same time, the slide buckles 833 slide toward the limiting flange 821 under the action of the second elastic reset member 835, until the slide buckles 833 hook the limiting flange 821 to limit an axial movement and a circumferential rotation of the turntable 82. In addition, under the action of the second elastic original member 835, the slide buckle 833 is maintained in a state of hooking and limiting the limiting flange 821, to ensure that the slide buckles 833 firmly hook and do not disengage from the limiting flange 821. Thus, the convenient mounting of the rotary base 8 is completed. The orientation of the intelligent waterless toilet may be adjusted according to an actual reserved position. The user may press the button 831 downward to cause the slide buckles 833 to disengage from the limiting flange 821, rotate the turntable 82 to any angle to adjust the orientation of the intelligent waterless toilet, and then release the button 831, thus completing the adjustment of the orientation of the intelligent waterless toilet.

When using the intelligent waterless toilet, a user can change the orientation of the intelligent waterless toilet according to his/her habit. There are two ways of changing the orientation of the intelligent waterless toilet. One is to directly rotate the housing 9 of the intelligent waterless toilet, so that the housing 9 of the intelligent waterless toilet overcomes resistance of the second elastic reset member 835 and drives the turntable 82 to rotate to adjust the orientation of the intelligent waterless toilet. The second elastic reset member 835 provides a certain damping effect during rotation of the turntable 82, improving the user's operation experience. The other is to press the button 831 downward to cause the slide buckles 833 to detach from the limiting flange 821. In this case, the turntable 82 can be rotated to any angle to adjust the orientation of the intelligent waterless toilet. As such, the force required to adjust the orientation of the intelligent waterless toilet is greatly reduced, making the operation more convenient, and allowing vulnerable groups to easily operate the intelligent waterless toilet.

### Embodiment 3

As shown in FIG. 16, an intelligent waterless toilet is provided. Different from Embodiment 2, in this embodiment, the rotary base 8 of the intelligent waterless toilet is replaced with a fixed base 8′, and the housing 9 of the intelligent waterless toilet is connected to the fixed base 8′. The fixed base 8′ has a simple structure and lower costs.

The foregoing descriptions are merely specific embodiments of the present disclosure, but are not intended to limit the protection scope of the present disclosure. Any equivalent replacement or variation made by those skilled in the art according to the technical solutions and inventive concept of the present disclosure within the technical scope disclosed in the present disclosure shall fall within the protection scope of the present disclosure.

What is claimed is:

1. An automatic packaging mechanism, comprising:
a hot melting assembly, wherein the hot melting assembly comprises a hot melting base and a heating structure arranged on the hot melting base;
a gathering assembly, wherein the gathering assembly comprises a gathering base and a pressing base, and the pressing base is arranged on the gathering base, a garbage bag passage is formed between the pressing base and the heating structure, a material strip of a garbage bag opened passes through the garbage bag passage, and the gathering base is configured to be driven by a gathering drive member to move toward or away from the heating structure; and
a buffer assembly, wherein the buffer assembly is slidably sleeved over an outer periphery of the hot melting base, and when the gathering drive member drives the gathering base to move toward the heating structure, the pressing base first comes into contact with the buffer assembly and then comes into contact with the heating structure, and an opening of a garbage bag to be heat-sealed is gathered between the pressing base and the heating structure by the gathering base; and
an upper part and a lower part of the heating structure are configured to simultaneously seal two garbage bags adjacent to each other, and a middle part of the heating structure is configured to cut the two sealed garbage bags apart from each other through melting.

2. The automatic packaging mechanism according to claim 1, wherein the buffer assembly comprises a buffer base and an elastic member, the buffer base is slidably sleeved over the outer periphery of the hot melting base, and the elastic member is arranged between the buffer base and the hot melting base.

3. The automatic packaging mechanism according to claim 2, wherein the buffer assembly further comprises a guide rod, the buffer base is slidably sleeved over the guide rod, a limiting member is arranged on the guide rod, and the buffer base is arranged between the limiting member and the elastic member.

4. The automatic packaging mechanism according to claim 3, wherein gathering portions are respectively arranged at an upper part and a lower part of the gathering base, the pressing base is arranged between the gathering portions at the upper part and the lower part of the gathering base, and each of the gathering portions has a flared shape toward the heating structure.

5. The automatic packaging mechanism according to claim 4, wherein the gathering drive member comprises a synchronous belt structure and a gathering motor, an output end of the gathering motor is drivingly connected to an input end of the synchronous belt structure, a left end and a right end of the gathering base are connected to the synchronous belt structure, and the gathering base is slidably sleeved over the guide rod of the buffer assembly.

6. The automatic packaging mechanism according to claim 1, wherein an exhaust sheet is arranged below the gathering base, a drawer is arranged below the garbage bag passage, the gathering base is configured to move toward the heating structure in a rear-to-front direction, and the exhaust sheet is arranged to be inclined forward in a top-to-bottom direction.

7. The automatic packaging mechanism according to claim 6, wherein the exhaust sheet is hingedly connected to the gathering base by a damping hinge, the exhaust sheet has a T-shape with a larger bottom and a smaller top, and a plurality of exhaust holes are formed through the exhaust sheet.

8. The automatic packaging mechanism according to claim 1, wherein the heating structure comprises a heating sheet and a thermally conductive sheet, the hot melting base, the heating sheet, and the thermally conductive sheet are arranged facing the gathering base in sequence, a middle part of the thermally conductive sheet is provided with a protruding portion extending toward the gathering base, and the protruding portion is configured to cut the two sealed garbage bags apart from each other through melting.

9. The automatic packaging mechanism according to claim 8, wherein the thermally conductive sheet is T-shaped.

10. The automatic packaging mechanism according to claim 8, wherein the thermally conductive sheet is made of copper.

11. The automatic packaging mechanism according to claim 8, wherein a high-temperature resistant diaphragm is attached to each of an inner side and an outer side of the thermally conductive sheet.

12. The automatic packaging mechanism according to claim 11, wherein the hot melting assembly further comprises a temperature sensor arranged on the hot melting base.

13. The automatic packaging mechanism according to claim 1, further comprising a garbage bag pull-down assembly, wherein the garbage bag pull-down assembly is arranged above the garbage bag passage, and is configured to convey the material strip of the garbage bag opened toward the garbage bag passage in turn.

14. The automatic packaging mechanism according to claim 13, further comprising a supporting base, wherein the hot melting assembly, the gathering assembly, and the garbage bag pull-down assembly are arranged in the supporting base.

15. An intelligent waterless toilet, comprising the automatic packaging mechanism according to claim 13, wherein the automatic packaging mechanism further comprises a supporting base, the hot melting assembly, the gathering assembly, and the garbage bag pull-down assembly are arranged in the supporting base, and the supporting base is arranged in a housing of the intelligent waterless toilet.

16. The intelligent waterless toilet according to claim 15, further comprising a fixed base, and the housing of the intelligent waterless toilet is connected to the fixed base.

17. The intelligent waterless toilet according to claim 15, further comprising a rotary base, wherein the intelligent waterless toilet is arranged in a recreational vehicle, and the housing of the intelligent waterless toilet is connected to the rotary base.

18. The intelligent waterless toilet according to claim 17, wherein the rotary base comprises a base body, a turntable, and a slide buckle drive member, the slide buckle drive member comprises a button, a lever assembly, and slide buckles, an annular groove is provided on an upper surface of the base body, the turntable is rotatably arranged in the annular groove, the turntable comprises a limiting flange extending outward along a radial direction of the turntable, the slide buckles are slidably arranged on the base body, the button and the lever assembly are arranged on the base body, an input end of the lever assembly is connected to the button, an output end of the lever assembly is connected to the slide buckles to drive the slide buckles to slide toward or away from the turntable, a first elastic reset member is arranged between the button and the base body, a second elastic reset member is arranged between each of the slide buckles and the base body, and when the slide buckles slide toward the turntable, the slide buckles hook the limiting flange to restrict an axial movement of the turntable, and each of the slide buckles radially presses against the turntable under an action of the second elastic reset member.

19. The intelligent waterless toilet according to claim 18, wherein the lever assembly comprises a push plate and two levers, the two levers are rotatably connected to the base body, the two levers are symmetrically arranged along the radial direction of the turntable, a distal end of each of the two levers is connected to a respective one of the slide buckles, the slide buckles are respectively provided with second limiting portions, and each of the second limiting portions extends downward from an end of a respective one of the slide buckles away from the limiting flange, and the distal end of each of the two levers is always in contact with a respective one of the second limiting portions; and a proximal end of each of the two levers is connected to the push plate, the push plate is connected to the button, the push plate comprises first limiting portions respectively extending from two sides of the push plate, the proximal end of each of the two levers is located between the first limiting portions on the two sides of the push plate, and when the button is pressed downward, the push plate presses the proximal end of each of the two levers simultaneously.

20. The intelligent waterless toilet according to claim 19, wherein an upper part of the turntable is arranged higher than the annular groove, a diameter of the upper part of the turntable is greater than a diameter of the annular groove, and the housing of the intelligent waterless toilet is connected to the upper part of the turntable; and the button is located on a front side of the intelligent waterless toilet.
